(19) United States
(12) Patent Application Publication
(10) Pub. No.: US 2015/0227755 A1
(43) Pub. Date: Aug. 13, 2015

(54) ENCRYPTION AND DECRYPTION METHODS OF A MOBILE STORAGE ON A FILE-BY-FILE BASIS

(71) Applicant: SAMSUNG ELECTRONICS CO., LTD., Suwon-si (KR)

(72) Inventors: JAE GYU LEE, Suwon-si (KR); JI SOO KIM, Yongin-si (KR); JONG BAE PARK, Siheung-si (KR); WON CHUL JU, Seoul (KR)

(21) Appl. No.: 14/621,625

(22) Filed: Feb. 13, 2015

(30) Foreign Application Priority Data
Feb. 13, 2014 (KR) 10-2014-0016393

(51) Int. Cl. G06F 21/62; G06F 12/14; H04L 9/08

(52) U.S. Cl. CPC G06F 21/6218; H04L 9/0863; G06F 12/1408

(57) ABSTRACT

A method for operating a system including a memory device and a host is provided. The method includes requesting, by the host, the memory device to transmit a context ID list including context IDs, assigning, by the host, a context ID among the context IDs to an application based on the context ID list received from the memory device, and transmitting, by the host, the context ID assigned to the application to the memory device when the host transmits a file corresponding to the application to the memory device or receives the file from the memory device.

### CROSS-REFERENCE TO RELATED APPLICATION

This application claims priority under 35 U.S.C. §119(a) to Korean Patent Application No. 10-2014-0016393, filed on Feb. 13, 2014, in the Korean Intellectual Property Office, the disclosure of which is incorporated by reference herein in its entirety.

### TECHNICAL FIELD

The present inventive concept relates to a method of performing encryption and decryption in a mobile storage on a file-by-file basis, and more particularly, to a method of operating a memory device that encrypts and decrypts a file using a context ID assigned to an application or a file related with the application.

### DISCUSSION OF THE RELATED ART

A host may perform encryption and decryption on a certain file. For instance, the host may encrypt a file using a cryptographic library when converting user data into the file and transmit the encrypted file to a mobile storage. In addition, the host may read the encrypted file from the mobile storage, decrypt the encrypted file at a file system level, and provide the decrypted file to a user application.

The host may need to change a data path of a file system to perform the encryption and decryption and thus, it may take a lot of time on the encryption and decryption. Accordingly, this may deteriorate performance of the host.

### SUMMARY

According to an exemplary embodiment of the present inventive concept, there is provided a method of operating a system including a memory device and a host. The method includes requesting, by the host, the memory device to transmit a context ID list including context IDs, assigning, by the host, a context ID among the context IDs to an application from the context ID list received from the memory device, and transmitting, by the host, the context ID assigned to the application to the memory device when the host transmits a file corresponding to the application to the memory device, or receives the file from the memory device.

The method may further include encrypting, by the memory device, the file using an encryption key corresponding to the application when the memory device receives the file from the host, and decrypting, by the memory device, the file using the encryption key when the memory device transmits the file to the host.

The method may further include invalidating, by the memory device, the encryption key when an invalidation command and the context ID are received from the host.

The method may further include transmitting, by the host, a password to the memory device together with the context ID assigned to the application and generating, by the memory device, a first authentication key corresponding to the application using the context ID and the password.

The password may be input by a user.

The password may be input from a server that communicates with the host.

The method may further include receiving, by the memory device, a new context ID and a new password from the host after generating the first authentication key, generating, by the memory device, a second authentication key using the new context ID and the new password, and comparing, by the memory device, the first authentication key with the second authentication key.

The method may further include transmitting, by the host, a command and the context ID to the memory device when the first authentication key and the second authentication key are the same as each other, encrypting, by the memory device, the file using the encryption key when the transmitted command is a write command, and decrypting, by the memory device, the file using the encryption key when the transmitted command is a read command.

According to an exemplary embodiment of the present inventive concept, there is provided a non-transitory computer readable recording medium of recording a computer program for performing a method. The method includes requesting, by the host, the memory device to transmit a context ID list including context IDs, assigning, by the host, a context ID among the context IDs to an application based on the context ID list received from the memory device, and transmitting, by the host, the context ID assigned to the application to the memory device when the host transmits a file corresponding to the application to the memory device, or receives the file from the memory device.

According to an exemplary embodiment of the present inventive concept, there is provided a method of operating a memory device. The method includes transmitting a context ID list including context IDs to a host in response to a command output from the host, receiving a context ID among the context IDs and a file from the host. The context ID and the file assigned to an application executed by the host, encrypting the file using an encryption key corresponding to the context ID, and storing an encrypted file in the memory device.

The receiving the context ID and the file may include receiving the context ID and a password corresponding to the context ID from the host, generating a first authentication key using the context ID and the received password, receiving a new context ID among the context IDs and a new password from the host, generating a second authentication key using the new context ID and the new password, and receiving the context ID and the file when the first authentication key is the same as the second authentication key.

The first authentication key and the second authentication key may be generated using a hash function or an advanced encryption standard (AES).

The context ID list may include different encryption keys respectively corresponding to the context IDs.

The method may further include receiving a read command and the context ID from the host, decrypting the encrypted file stored in the memory device using the encryption key; and transmitting the decrypted file to the host.

The method may further include receiving an invalidation command and the context ID from the host and invalidating the encryption key corresponding to the received context ID in response to the invalidation command.

The memory device may be an embedded multimedia card (eMMC) or a universal flash storage (UFS).

According to an exemplary embodiment of the present inventive concept, there is provided a method for operating a system including a memory device and a host. The method includes assigning, by the host, an application and a file generated by the application to a security group having a particular security policy, assigning, by the host, a context ID to the security group, transmitting, by the host, the context ID when the application is executed to the memory device, detecting, by the memory device, a use status of the transmitted context ID, transmitting, by the memory device, a first response including the detected use status of the context ID to the host, transmitting, by the host, the file and one of the context ID or an unique ID corresponding to the context ID to the memory device, encrypting, by the memory device, the file using an encryption key corresponding to the context ID device, and storing the encrypted file in the memory device. The encryption key is stored in an internal memory in the memory device.

When the use status indicates that the context ID has not been used, the method may further include the transmitting of the first response and the transmitting of the file and one of the context ID or the unique ID transmitting, by the host, an authentication request including the context ID to the memory device, generating, by the memory device, the encryption key corresponding to the context ID, storing the encryption key in the internal memory; and transmitting, by the memory device, a second response indicating that the encryption key is generated to the host. The preceding steps may be performed between the transmitting of the first response and the transmitting of the file and one of the context ID or the unique ID.

When the use status indicates that the context ID has not been used, the method may further include transmitting, by the host, an authentication request including the context ID to the memory device, generating, by the memory device, the encryption key corresponding to the context ID, generating, by the memory device, the unique ID, storing, by the memory device, the unique ID in the internal memory, and transmitting, by the memory device, a second response including the unique ID to the host when the use status indicates that the context ID has not been used. The preceding steps may be performed between the transmitting of the first response and the transmitting of the file and one of the context ID or the unique ID.

The method may further include comparing, by the memory device, the unique ID transmitted from the host with the unique ID stored in the memory device.

### BRIEF DESCRIPTION OF THE DRAWINGS

The above and other features of the present inventive concept will become more apparent by describing in detail exemplary embodiments thereof with reference to the attached drawings in which:

FIG. 1 is a block diagram of a data processing system according to an exemplary embodiment of the present inventive concept;

FIG. 2 is a flowchart for explaining initialization of the data processing system illustrated in FIG. 1;

FIG. 3 is a diagram of a context ID list stored in a memory device illustrated in FIG. 1 according to an exemplary embodiment of the present inventive concept;

FIG. 4 is a diagram of a context ID list stored in the memory device illustrated in FIG. 1 according to an exemplary embodiment of the present inventive concept;

FIG. 5 is a flowchart for explaining a write operation of the data processing system illustrated in FIG. 1 according to an exemplary embodiment of the present inventive concept;

FIG. 6 is a flowchart for explaining a read operation of the data processing system illustrated in FIG. 1 according to an exemplary embodiment of the present inventive concept;

FIG. 7 is a flowchart for explaining encryption key cancellation of the data processing system illustrated in FIG. 1 according to an exemplary embodiment of the present inventive concept;

FIG. 8 is a block diagram of a host illustrated in FIG. 1;

FIG. 9 is a block diagram of the memory device illustrated in FIG. 1;

FIG. 10 is a flowchart for explaining a write operation of the data processing system illustrated in FIG. 1 according to an exemplary embodiment of the present inventive concept;

FIG. 11 is a diagram for explaining an operation of the host illustrated in FIG. 1 that assigns an application and a file to a security group;

FIG. 12 is a flowchart for explaining a write operation of the data processing system illustrated in FIG. 1 according to an exemplary embodiment of the present inventive concept;

FIG. 13 is a flowchart for explaining a read operation of the data processing system illustrated in FIG. 1 according to an exemplary embodiment of the present inventive concept;

FIG. 14 is a flowchart for explaining a method of processing an unauthorized context ID using the data processing system illustrated in FIG. 1 according to an exemplary embodiment of the present inventive concept; and

FIG. 15 is a diagram for explaining an operation of a mobile device when the data processing system illustrated in FIG. 1 is the mobile device.

### DETAILED DESCRIPTION OF THE EMBODIMENTS

The present inventive concept will now be described more fully hereinafter with reference to the accompanying drawings, in which exemplary embodiments thereof are shown. This present inventive concept may, however, be embodied in many different forms and should not be construed as limited to the embodiments set forth herein. In the drawings, the size and relative sizes of layers and regions may be exaggerated for clarity. Like numbers may refer to like elements throughout the specification and drawings.

It will be understood that when an element is referred to as being “connected” or “coupled” to another element, it can be directly connected or coupled to the other element or intervening elements may be present.

As used herein, the singular forms “a”, “an” and “the” are intended to include the plural forms as well, unless the context clearly indicates otherwise.

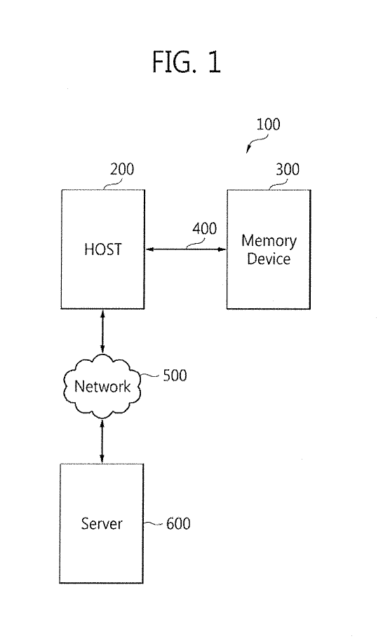

FIG. 1 is a block diagram of a data processing system 100 according to an exemplary embodiment of the present inventive concept. Referring to FIG. 1, the data processing system 100 may include a host 200 and a memory device 300.

The data processing system 100 may provide security on a file-by-file basis or an application-by-application basis instead of on a partition-by-partition basis. Since a file may be generated or executed by an application, the operation of the data processing system 100 that provides the file-based security (e.g., the security provided on the file-by-file basis) will be described in detail hereinafter. For example, the file-based security may be interpreted as covering the application-based security.

The data processing system 100 may be implemented as a personal computer (PC), a server, a database, a portable electronic device, or the like. The portable electronic device may be a mobile telephone, a smart phone, a tablet PC, a mobile internet device (MID), an internet of things (IoT) device, an internet of everything (IoE) device, a wearable computer, or the like.

The host 200 may control a write operation and a read operation on the memory device 300 through an interface 400. The host 200 may be implemented in an integrated circuit (IC), a system on chip (SoC), an application processor (AP), a mobile AP, a printed circuit board (PCB), or the like. The host 200 may be implemented as a memory controller or may function as the memory controller. The host 200 according to an exemplary embodiment of the present inventive concept may not perform either encryption or decryption on a file.

The memory device 300 may be a data storage removable from the host 200 or a mobile storage. The memory device 300 may be implemented as a flash-based memory device. The flash-based memory device may be implemented as a multimedia card (MMC), an embedded MMC (eMMC), a universal flash storage (UFS), a universal serial bus (USB) flash driver, or an embedded solid state drive (eSSD).

The host 200 may be connected to a server 600 through a network 500. The network 500 may be a wired or wireless network. The wireless network may be an internet, a Wi-Fi network, a mobile communication network, or the like. The server 600 may communicate commands and/or data with the host 200 through the network 500.

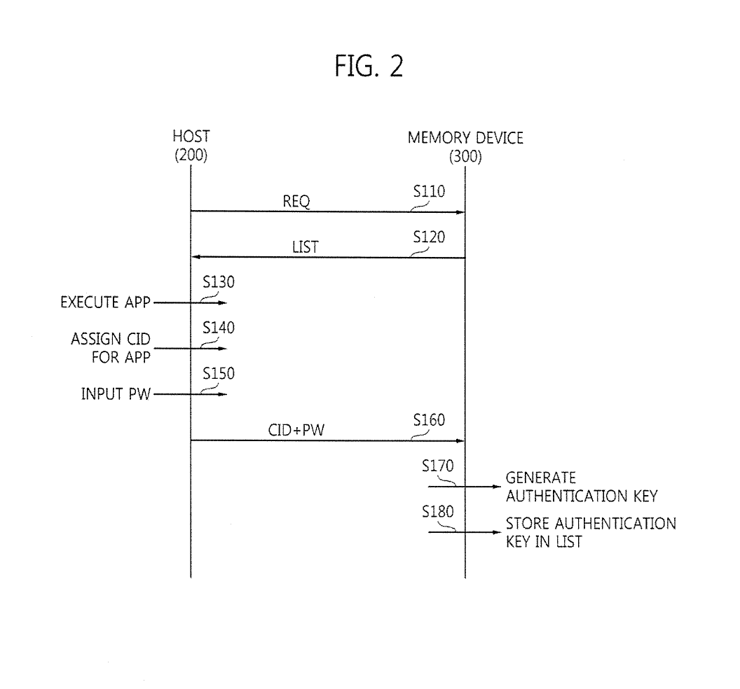

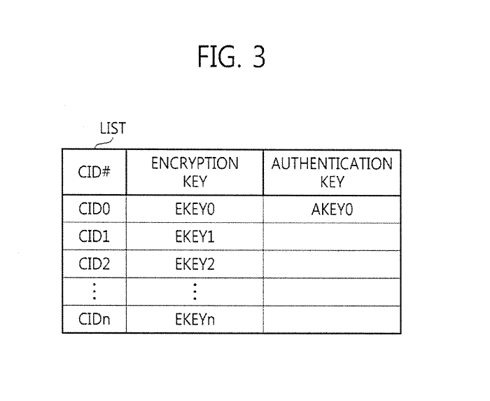

FIG. 2 is a flowchart for explaining initialization of the data processing system 100 illustrated in FIG. 1. FIG. 3 is a diagram of a context ID list stored in the memory device 300 illustrated in FIG. 1 according to an exemplary embodiment of the present inventive concept.

The initialization of the data processing system 100 will be described in detail with reference to FIGS. 1 through 3. As shown in FIG. 3, a list of context IDs CID0 through CIDn (where “n” is a natural number) may be stored in an internal memory of the memory device 300. The list may be programmed or set by a manufacturer of the memory device 300.

Information included in the list may vary with exemplary embodiments of the present inventive concept. For clarity of the description, it is assumed in the embodiments illustrated in FIG. 3 that encryption keys EKEY0 through EKEYn are respectively assigned for the context IDs CID0 through CIDn and an authentication key (e.g., AKEY0) for each of the context IDs CID0 through CIDn may be generated by the memory device 300 using each context ID and/or a password received from the host 200.

The context IDs CID0 through CIDn may be used in the memory device 300 or supported by the memory device 300. Here, a context ID may indicate an identifier that identifies a transaction context. The transaction context may include parameters defining an operation to be performed according to the context ID. The context ID and the transaction context may be included in a command. The memory device 300 may analyze the transaction context included in the command and may perform an operation defined in the transaction context according to the analysis result.

The host 200 may transmit a request signal REQ requesting the transmission of the context ID list to the memory device 300 in operation S110. The memory device 300 may transmit the context ID list to the host 200 in response to the request signal REQ in operation S120. In an exemplary embodiment of the present inventive concept, the context ID list may include only the context IDs CID0 through CIDn.

When an application APP is installed or executed in the host 200 in operation S130, the host 200, e.g., an operating system (OS) may assign one of the context IDs CID0 through CIDn included in the context ID list to the application APP in operation S140. For instance, when a plurality of applications APP is installed in the host 200, the host 200 may assign each of the context IDs CID0 through CIDn to each of the plurality of applications APP and thus, one context ID is assigned to at least one application APP. For instance, one or more applications APP may be assigned to the same context ID (e.g., CID0), and the context ID may be assigned to a file or files generated by the one or more applications APP.

When a password PW needs to be set for an application APP or a file related with the application APP, the host 200 may receive the password PW that has been input by a user or transmitted from the server 600 through the network 500 in operation S150. The host 200 may transmit the assigned context ID (e.g., CID0) and the password PW to the memory device 300 in operation S160.

In an exemplary embodiment of the present inventive concept, the memory device 300 may generate an authentication key (e.g., AKEY0) using the password PW in operation S170 and may store the authentication key in the context ID list in operation S180. In an exemplary embodiment of the present inventive concept, the memory device 300 may generate an authentication key (e.g., AKEY0) using the context ID (e.g., CID0) and the password PW in operation S170 and may store the authentication key in the context ID list in operation S180. In an exemplary embodiment of the present inventive concept, the memory device 300 may generate the authentication key using an advanced encryption standard (AES) or a hash function.

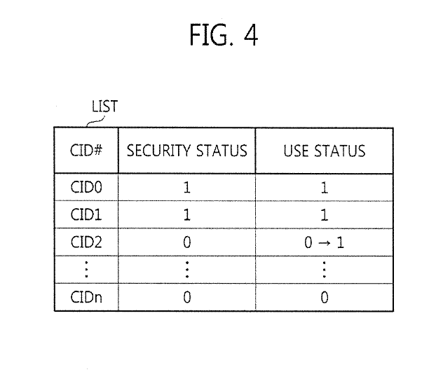

FIG. 4 is a diagram of a context ID list stored in the memory device 300 illustrated in FIG. 1 according to an exemplary embodiment of the present inventive concept. Referring to FIG. 4, the context ID list may include information about security status (e.g., whether a password exists or not) and information about use status of a context ID (e.g., whether a context ID is used or not) with respect to each of the context IDs CID0 through CIDn.

For instance, when the security status for a certain context ID (e.g., CID0 or CID1) is set to “1”, it means that the certain context ID belongs to a security group, and therefore, security is needed for a corresponding application APP or file. Accordingly, a password may be required to process (e.g., write or read) the application APP to which the context ID is assigned or a file related with the application APP.

In addition, when the use status for a certain context ID (e.g., CID0 or CID1) is set to “1”, it means that the certain context ID (e.g., CID0 or CID1) has been assigned to an application APP. For instance, when a context ID (e.g., CID2) that has not been used before is received from the host 200, the memory device 300 may change the use status of the context ID (e.g., CID2) from “0” to “1”.

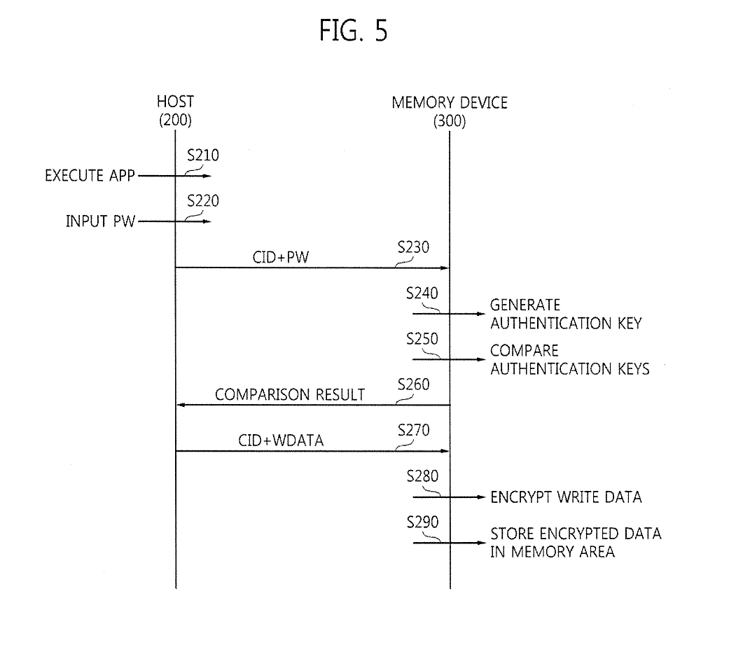

FIG. 5 is a flowchart for explaining a write operation of the data processing system 100 illustrated in FIG. 1 according to an exemplary embodiment of the present inventive concept. Referring to FIGS. 1, 2, 3, and 5, when the application APP is executed in operation S210 and the password PW is input in operation S220, the host 200 transmits a context ID (e.g., CID0) assigned to the application APP and the password PW to the memory device 300 in operation S230.

The memory device 300 may generate the authentication key (e.g., AKEY0) using the password PW in operation S240. In addition, the memory device 300 may generate the authentication key (e.g., AKEY0) using the context ID (e.g., CID0) and the password PW in operation S240, as described above.

To authenticate an application APP requiring security, the memory device 300 compares the authentication key stored in the list in operation S180 with the authentication key AKEY0 generated in operation S240 in operation S250. The memory device 300 transmits a response signal including the comparison result to the host 200 in operation S260.

When the comparison result indicates that authentication has succeeded (e.g., when the authentication key stored in the list in operation S180 is the same as the authentication key generated in operation S240), the host 200 may transmit a command and a write file WDATA to the memory device 300 in operation S270. The command may include the context ID (e.g., CID0). The write file WDATA may be a file generated by the application APP to which the context ID is assigned (e.g., CID0). In addition, when the comparison result indicates that the authentication has failed, the host 200 may not perform the operation S270. In an exemplary embodiment of the present inventive concept, when the write file WDATA is transmitted in a plurality of segments, the host 200 may transmit the context ID (e.g., CID0) together with each of the segments in operation S270.

In addition, the memory device 300 may encrypt the write file WDATA using an encryption key (e.g., EKEY0) related with the context ID (e.g., CID0) in operation S280 and may store the encrypted write file in a memory area in the memory device 300, e.g., a non-volatile memory area in operation S290.

For example, the host 200 assigns a certain context ID (e.g., CID0) to an application APP using (or retelling to) a context ID list, and transmits the assigned context ID together with a file (e.g., the write file WDATA) to the memory device 300 when writing the file to the memory device 300. The memory device 300 may encrypt the file using an encryption key (e.g., EKEY0) corresponding to the context ID (e.g., CID0) received together with the file, and may store the encrypted file in a memory area of the memory device 300.

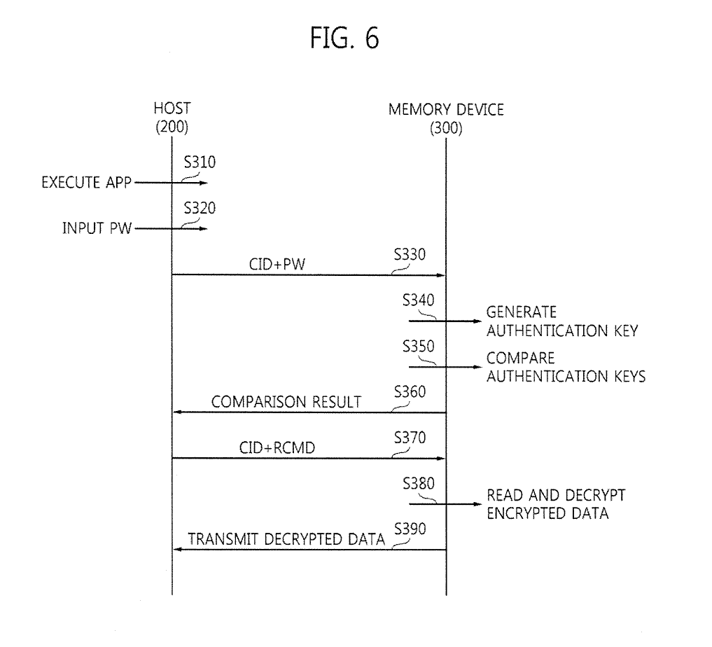

FIG. 6 is a flowchart for explaining a read operation of the data processing system 100 illustrated in FIG. 1 according to an exemplary embodiment of the present inventive concept. Referring to FIGS. 1, 2, 3, and 6, when the application APP is executed in operation S310 and the password PW is input in operation S320, the host 200 transmits a context ID (e.g., CID0) assigned to the application APP and the password PW to the memory device 300 in operation S330.

The memory device 300 may generate an authentication key (e.g., AKEY0) using the password PW in operation S340. In addition, the memory device 300 may generate the authentication key (e.g., AKEY0) using the context ID (e.g., CID0) and the password PW in operation S340, as described above. The memory device 300 compares the authentication key stored in the list in operation S180 with the authentication key (e.g., AKEY0) generated in operation S340 in operation S350.

The memory device 300 transmits a response signal including the comparison result to the host 200 in operation S360. When the comparison result indicates that authentication has succeeded, the host 200 may transmit the context ID (e.g., CID0) and a read command RCMD to the memory device 300 in operation S370.

The memory device 300 reads an encrypted file from a memory area defined by the read command RCMD and decrypts the encrypted file using the encryption key (e.g., EKEY0) related with the context ID (e.g., CID0) in operation S380. The memory device 300 transmits the decrypted file to the host 200 in operation S390.

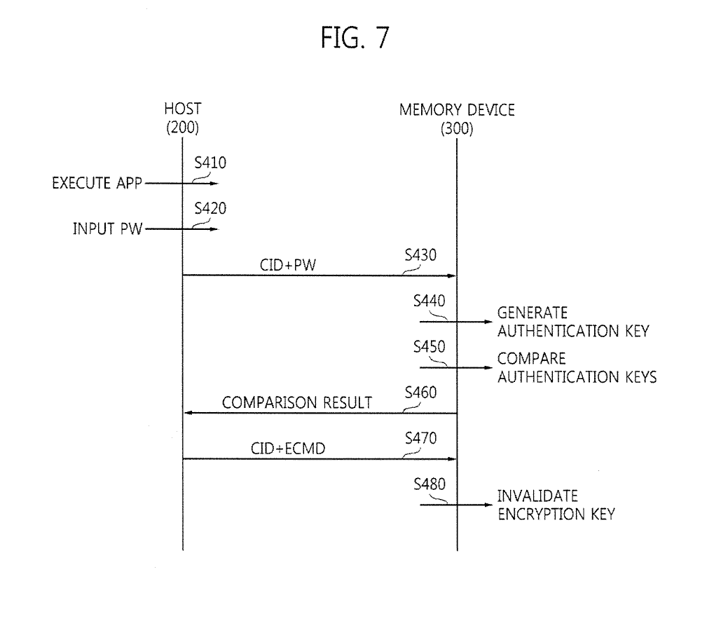

FIG. 7 is a flowchart for explaining encryption key cancellation (or invalidation) of the data processing system 100 illustrated in FIG. 1 according to an exemplary embodiment of the present inventive concept. Referring to FIGS. 1, 2, 3, and 7, when the application APP is executed in operation S410 and the password PW is input in operation S420, the host 200 transmits a context ID (e.g., CID0) assigned to the application APP and the password PW to the memory device 300 in operation S430.

The memory device 300 may generate an authentication key (e.g., AKEY0) using the password PW in operation S440. In addition, the memory device 300 may generate an authentication key (e.g., AKEY0) using the context ID (e.g., CID0) and the password PW in operation S440, as described above.

The memory device 300 compares the authentication key stored in the list in operation S180 with the authentication key generated in operation S440 in operation S450. The memory device 300 transmits a response signal including the comparison result to the host 200 in operation S460. When the comparison result indicates that the authentication has succeeded, the host 200 transmits the context ID (e.g., CID0) and a cancellation (or an invalidation) command ECMD to the memory device 300 in operation S470. The memory device 300 may cancel (or invalidate) the encryption key (e.g., EKEY0) corresponding to the context ID (e.g., CID0) according to the cancellation command ECMD in operation S480. The cancellation (or invalidation) may be an act of erasing or unloading.

The method of cancelling (or invalidating) the encryption key (e.g., EKEY0) related with the context ID (e.g., CID0) according to the cancellation command ECMD is illustrated in FIG. 7. However, in an exemplary embodiment of the present inventive concept, when the application APP corresponding to the context ID (e.g., CID0) has not accessed the memory device 300 for a predetermined period of time, the memory device 300 may automatically cancel (or invalidate) the authentication key (e.g., AKEY0) corresponding to the context ID (e.g., CID0). In an exemplary embodiment of the present inventive concept, the memory device 300 may automatically cancel (or invalidate) the authentication key (e.g., AKEY0) corresponding to the context ID (e.g., CID0) at power-on reset (POR).

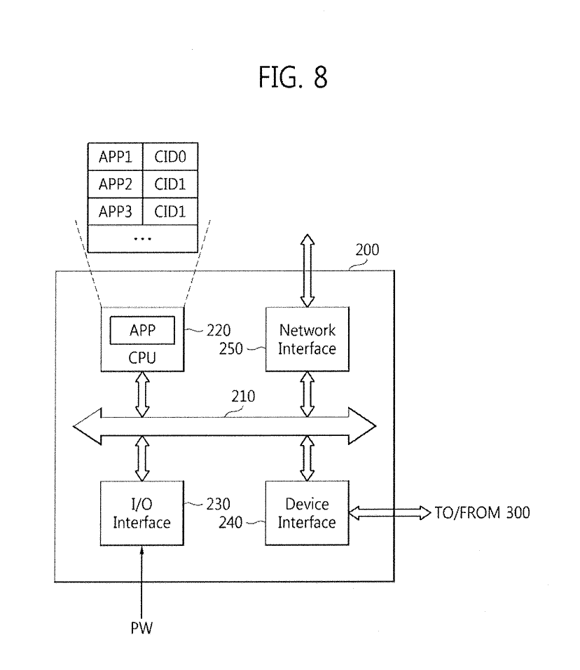

FIG. 8 is a block diagram of the host 200 illustrated in FIG. 1. Referring to FIGS. 1 through 8, the host 200 may include a central processing unit (CPU) 220, an input/output (I/O) interface 230, a device interface 240, and a network interface 250.

The CPU 220 may execute the application APP. An OS executed in the CPU 220 or a program for realizing an exemplary embodiment of the present inventive concept may allow the CPU 220 to receive the context ID list and to assign a context ID to an application APP according to a security policy or level with reference to the context ID list.

For instance, the CPU 220 may assign the context ID CID0 to an application APP1 and assign the context ID CID1 to both applications APP2 and APP3. A security group may be defined for each of the context IDs (e.g., CID0 and CID1). The same security policy may be applied to at least one application APP or file when the at least one application APP or file belongs to a security group. For example, each of the applications APP1 through APP3 may be referred to as the application APP.

The CPU 220 may control the operations of the elements 230, 240, and 250 through a bus 210 and may communicate data and/or control signals with the elements 230, 240, and 250 through the bus 210. The I/O interface 230 may transmit the password PW input by a user to the CPU 220 through the bus 210. The I/O interface 230 may be implemented as a display controller, a touch panel controller, or the like.

The device interface 240 may communicate data and/or commands with the memory device 300 through the interface 400. The network interface 250 may communicate data and/or commands with the server 600 through the network 500. The network interface 250 may transmit the password PW from the server 600 to the CPU 220 through the bus 210.

For instance, when a user uses a particular application APP, the CPU 220 transmits a request signal requesting the use of the particular application APP to the server 600 through the elements 210, 250, and 500. In addition, the server 600 may transmit the password PW for permitting the use of the particular application APP to the CPU 220 through the elements 210, 250, and 500.

Referring to FIGS. 1 through 8, the host 200 may assign the context IDs CID0 through CIDn to each of applications APP using the context ID list. When any one of the applications APP writes a file to the memory device 300, the host 200 may transmit a context ID assigned to the application APP among the context IDs CID0 through CIDn and the file to the memory device 300.

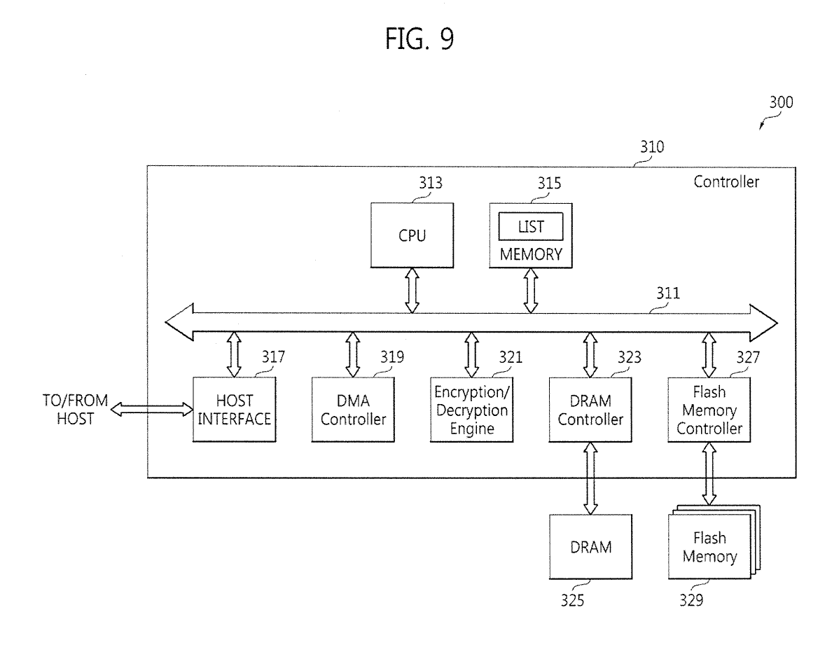

FIG. 9 is a block diagram of the memory device 300 illustrated in FIG. 1. Referring to FIG. 9, the memory device 300 may include a controller 310, a first memory 325, and a second memory 329. The memory device 300 may be implemented as an MMC, an eMMC, a UFS, an SSD, or an eSSD.

The controller 310 may interface data among the host 200, the first memory 325, and the second memory 329. The controller 310 may be implemented in an IC or a SoC. The controller 310 may include a CPU 313, an internal memory 315, a host interface 317, a direct memory access (DMA) controller 319, an encryption/decryption engine 321, a first memory controller 323, and a second memory controller 327.

The CPU 313 or a program executed in the CPU 313 may control the overall operation of the controller 310. For instance, the CPU 313 may be implemented as a multi-core processor. The CPU 313 may control the operations of the elements 315, 317, 319, 321, 323, and 327. For instance, the CPU 313 may perform transmission of the context ID list (S210), generation of the authentication key (S170, S240, S340, or S440), storing of the authentication key (S180), comparison of authentication keys (S250, S350, or S450), and transmission of a comparison result (S260, S360, or S460).

The internal memory 315 may store the context ID list. Here, the internal memory 315 may be a set of volatile memory and non-volatile memory. In an exemplary embodiment of the present inventive concept, the context ID list may be pre-stored in the internal memory 315. In an exemplary embodiment of the present inventive concept, the context ID list may be loaded from the second memory 329 to the internal memory 315 when the memory device 300 is booted.

The host interface 317 may communicate data and/or commands with the device interface 240 in the host 200 through the interface 400. The DMA controller 319 may transmit and receive an encrypted file or a decrypted file to and from the encryption/decryption engine 321. The DMA controller 319 may control data transferred between the host interface 317 and the encryption/decryption engine 321.

The encryption/decryption engine 321 may generate an authentication key related with a context ID using the context ID and/or the password PW output from the host 200. In addition, the encryption/decryption engine 321 may encrypt a write file and decrypt the encrypted write file using an encryption key (e.g., EKEY0) related with the context ID.

The first memory controller 323 may write data to the first memory 325 and may read data from the first memory 325. When the first memory 325 is implemented as a dynamic random access memory (DRAM), the first memory controller 323 may be implemented as a DRAM controller.

The second memory controller 327 may write data to the second memory 329 and may read data from the second memory 329. For instance, the second memory controller 327 may write encrypted data to the second memory 329 and may read encrypted data from the second memory 329. The second memory 329 may be implemented as a flash-based memory. For instance, the flash-based memory may include NAND flash memory cells, NOR flash memory cells, or the like.

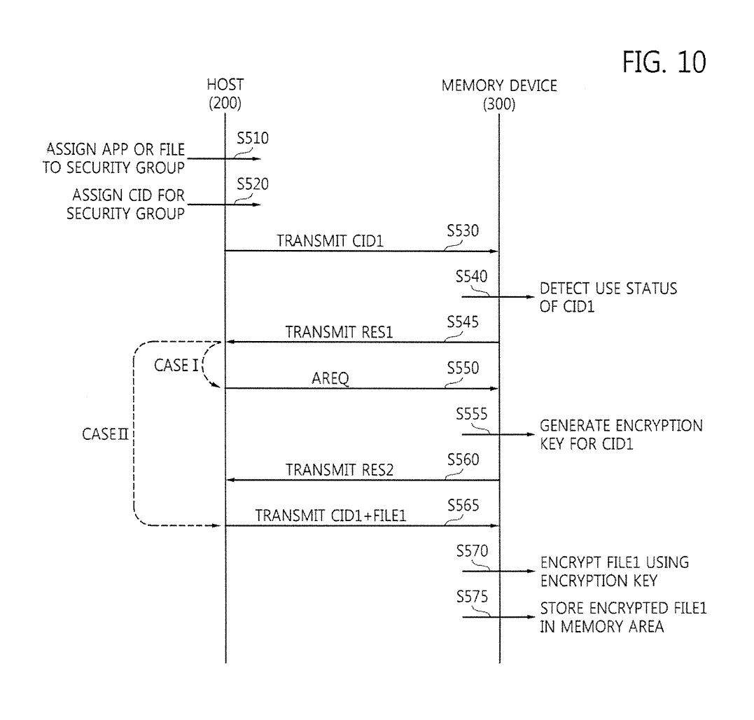

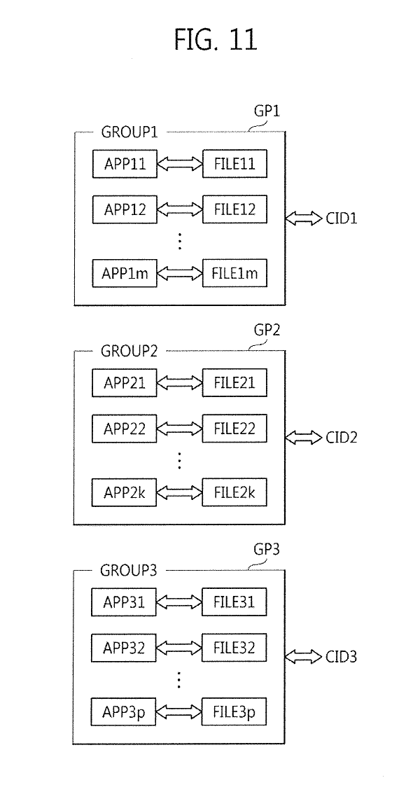

FIG. 10 is a flowchart for explaining a write operation of the data processing system 100 illustrated in FIG. 1 according to an exemplary embodiment of the present inventive concept. FIG. 11 is a diagram for explaining an operation of the host 200 illustrated in FIG. 1 that assigns an application and a file to a security group.

Referring to FIGS. 1, 9, 10, and 11, the host 200 may assign an application APP or a file generated by the application APP to a security group. For instance, when applications APP11 through APP1m, APP21 through APP2k, and APP31 through APP3p (where “m”, “n”, and “p” are natural numbers) are installed in the host 200, the CPU 220 of the host 200 may assign the applications APP11 through APP1m to a first security group GP1 in operation S510. In addition, the CPU 220 of the host 200 may assign files FILE11 through FILE1m respectively generated by the applications APP11 through APP1m to the first security group GP1 in operation S510.

The CPU 220 of the host 200 may assign the applications APP21 through APP2k to a second security group GP2 in operation S510. In addition, the CPU 220 of the host 200 may assign files FILE21 through FILE2k respectively generated by the applications APP21 through APP2k to the second security group GP2 in operation S510. The CPU 220 of the host 200 may assign the applications APP31 through APP3p to a third security group GP3 in operation S510. In addition, the CPU 220 of the host 200 may assign files FILE31 through FILE3p respectively generated by the applications APP31 through APP3p to the third security group GP3 in operation S510.

The security groups GP1, GP2, and GP3 may have different security policies or levels from one another. For instance, the first security group GP1 may be a non-security group, the second security group GP2 may be a personal security group, and the third security group GP3 may be a business security group. For instance, the applications APP11 through APP1m and/or the files FILE11 through FILE1m belonging to the first security group GP1 may have a non-security attribute. The applications APP21 through APP2k and/or the files FILE21 through FILE2k belonging to the second security group GP2 may have a personal security attribute. The applications APP31 through APP3p and/or the files FILE31 through FILE3p belonging to the third security group GP3 may have a business security attribute.

The CPU 220 of the host 200 may assign the context IDs CID1, CID2, and CID3 to the security groups GP1, GP2, and GP3 in operation S520. Hereinafter, a procedure in which the applications APP11 through APP1m belonging to the first security group GP1 process each of the files FILE11 through FILE1m belonging to the first security group GP1 using the context ID CID1 will be described.

When the application APP11 is executed or when a write operation of the file FILE1 is performed, the CPU 220 of the host 200 transmits the context ID (e.g., CID1) related with the application APP11 or the file FILE1 to the memory device 300 in operation S530. In addition, the CPU 313 of the memory device 300 detects the use status of the context ID (e.g., CID1) in operation S540. The use status of the context ID (e.g., CID1) may have been stored in the internal memory 315.

In a first case CASE I where the use status indicates that the context ID CID1 has not been used, the CPU 313 of the memory device 300 transmits a first response RES1 indicating that the context ID CID1 has not been used to the host 200 in operation S545. The CPU 220 of the host 200 transmits an authentication request AREQ including the context ID CID1 to the memory device 300 in operation S550.

The encryption/decryption engine 321 of the memory device 300 generates an encryption key for the context ID CID1 and stores the encryption key in the internal memory 315 in operation S555. When the encryption key is generated for the context ID CID1, the CPU 313 of the Memory device 300 transmits a second response RES2 indicating that the encryption key has been generated to the host 200 in operation S560.

The CPU 220 of the host 200 transmits the context ID CID1 and the file FILE1 to the memory device 300 in operation S565. The encryption/decryption engine 321 encrypts the file FILE1 using the encryption key stored in the internal memory 315 according to the control of the CPU 313 in operation S570. The second memory controller 327 stores the file FILE1 that has been encrypted by the encryption/decryption engine 321 in a memory area of the second memory 329 according to the control of the CPU 313 in operation S575.

In a second case CASE II where the use status indicates that the context ID CID1 has been used and the encryption key for the context ID CID1 has been generated in operation S555, the CPU 313 of the memory device 300 transmits the first response RES1 indicating that the context ID CID1 has been used to the host 200 in operation S545. The CPU 220 of the host 200 transmits the context ID CID1 and the file FILE1 to the memory device 300 in operation S565.

The encryption/decryption engine 321 encrypts the file FILE1 using the encryption key that has been stored in the internal memory 315 in operation S555 according to the control of the CPU 313 in operation S570. The second memory controller 327 stores the file FILE1 that has been encrypted by the encryption/decryption engine 321 in a memory area of the second memory 329 according to the control of the CPU 313 in operation S575.

Thus, when processing the applications APP11 through APP1m or the files FILE11 through FILE1m belonging to the first security group GP1, the CPU 220 of the host 200 may use the context ID CID1.

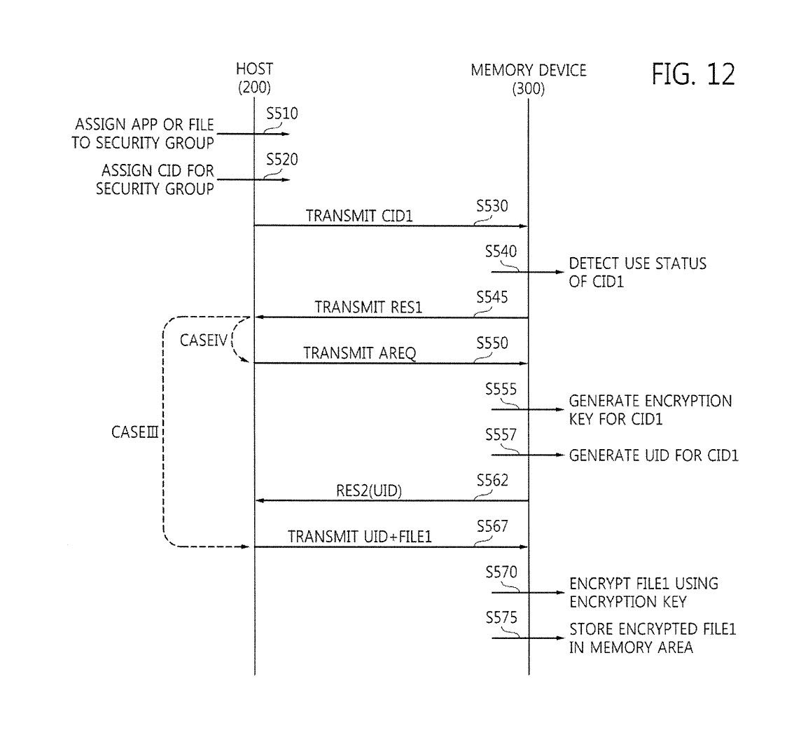

FIG. 12 is a flowchart for explaining a write operation of the data processing system 100 illustrated in FIG. 1 according to an exemplary embodiment of the present inventive concept.

Referring to FIGS. 10 and 12, in a fourth case CASE IV where the use status indicates that the context ID CID1 has not been used, the CPU 313 of the memory device 300 transmits the first response RES1 indicating that the context ID CID1 has not been used to the host 200 in operation S545. The CPU 220 of the host 200 transmits the authentication request AREQ including the context ID CID1 to the memory device 300 in operation S550.

The encryption/decryption engine 321 of the memory device 300 generates an encryption key for the context ID CID1, generates a unique identifier UID corresponding to the context ID CID1 or the encryption key, and stores the unique identifier UID in the internal memory 315 of the memory device 300 in operation S557. For example, the generated encryption key for the context ID CID1 may be stored in the internal memory 315. When the unique identifier UID corresponding to the context ID CID1 is generated in operation S557, the CPU 313 of the memory device 300 transmits the second response RES2 including the unique identifier UID to the host 200 in operation S562.

The CPU 220 of the host 200 transmits the unique identifier UID and the file FILE1 to the memory device 300 in operation S567. The CPU 313 of the memory device 300 compares the unique identifier UID transmitted from the host 200 with the unique identifier UID that has been stored in the internal memory 315.

The encryption/decryption engine 321 encrypts the file FILE1 using the encryption key stored in the internal memory 315 according to the comparison result in operation S570. The second memory controller 327 stores the file FILE1 that has been encrypted by the encryption/decryption engine 321 in a memory area of the second memory 329 according to the control of the CPU 313 in operation S575.

In a third case CASE III where the context ID CID1 has been used and the unique identifier UID corresponding to the context ID CID1 has been generated in operation S557, the CPU 313 of the memory device 300 transmits the first response RES1 indicating that the context ID CID1 has been used to the host 200 in operation 5545. The CPU 220 of the host 200 transmits the unique identifier UID and the file FILE1 to the memory device 300 in operation S567.

The CPU 313 of the memory device 300 compares the unique identifier UID transmitted from the host 200 with the unique identifier UID that has been stored in the internal memory 315. The encryption/decryption engine 321 encrypts the file FILE1 using the encryption key stored in the internal memory 315 according to the comparison result in operation S570. The second memory controller 327 stores the file FILE1 that has been encrypted by the encryption/decryption engine 321 in a memory area of the second memory 329 according to the control of the CPU 313 in operation S575.

Thus, when processing the applications APP11 through APP1m or the files FILE11 through FILE1m belonging to the first security group GP1, the CPU 220 of the host 200 may use the context ID CID1 or the unique identifier UID.

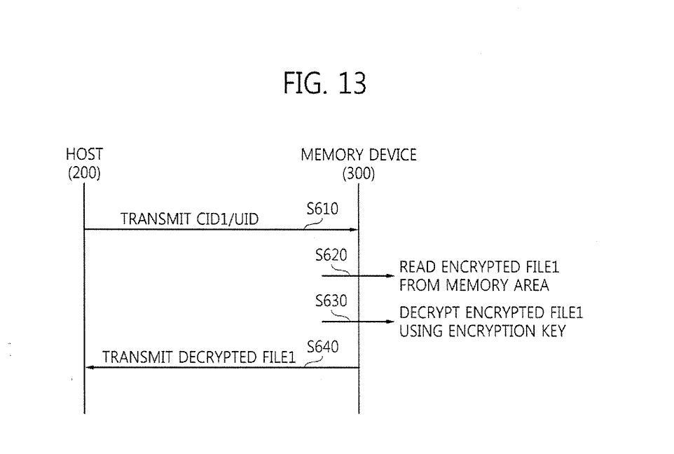

FIG. 13 is a flowchart for explaining a read operation of the data processing system 100 illustrated in FIG. 1 according to an exemplary embodiment of the present inventive concept. A procedure in which the application APP11 reads the file FILE1 using the context ID CID1 or the unique identifier UID will be described with reference to FIGS. 8, 9, 11, and 13.

The CPU 220 of the host 200 transmits a read command including the context ID CID1 or the unique identifier UID to the memory device 300 in operation S610. The read command includes information about a storage position of a file to be read.

The CPU 313 of the memory device 300 analyzes the read command and transmits the analysis result to the second memory controller 327. The second memory controller 327 reads the encrypted file from the second memory 329 in operation S620. The encryption/decryption engine 321 decrypts the encrypted file read from the second memory controller 327 using an encryption key stored in the internal memory 315 in operation S630. The memory device 300 transmits the decrypted file to the host 200 in operation S640.

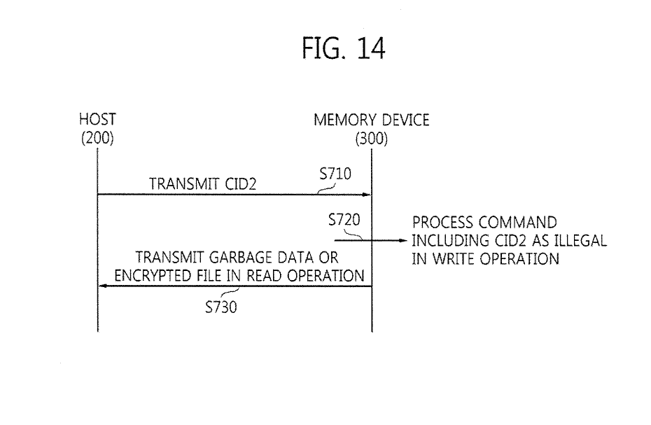

FIG. 14 is a flowchart for explaining a method of processing an unauthorized context ID using the data processing system 100 illustrated in FIG. 1 according to an exemplary embodiment of the present inventive concept. When the applications APP21 through APP2k belonging to the second security group GP2 perform a write operation on the file FILE11 belonging to the first security group GP1 using the context ID CID2, the host 200 transmits a write command including the context ID CID2 to the memory device 300 in operation S710. The CPU 313 of the memory device 300 analyzes the write command and processes the write command including the context ID CID2 as an illegal command according to the analysis result in operation S720.

When the applications APP21 through APP2k belonging to the second security group GP2 perform a read operation on a file stored in the second memory 329 using the context ID CID2, the host 200 transmits a read command including the context ID CID2 to the memory device 300 in operation S710. The CPU 313 of the memory device 300 analyzes the read command and transmits garbage data or an encrypted file that has not been decrypted to the host 200 according to the analysis result in operation S730. Since the host 200 does not have an encryption key, the host 200 cannot decrypt the encrypted file.

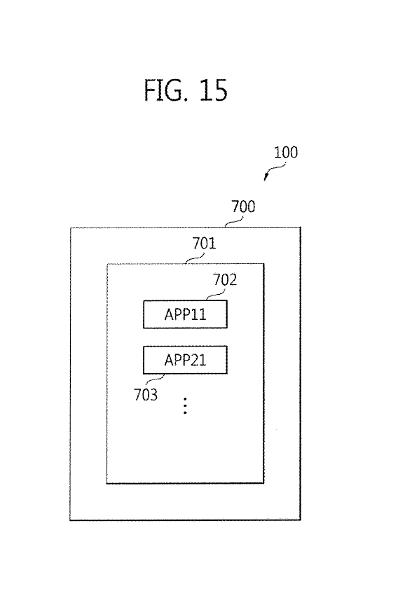

FIG. 15 is a diagram for explaining an operation of a mobile device 100 when the data processing system 100 illustrated in FIG. 1 is the mobile device 100. Referring to FIGS. 1 through 15, graphical user interfaces (GUIs) 702 and 703 corresponding to applications APP11 and APP21, respectively, are displayed in a GUI display area 701 of a display 700 included in the data processing system 100. Each of the applications APP11 and APP21 may be executed by selecting or touching each of the GUIs 702 and 703.

When the application APP11 or APP21 is executed, the CPU 220 of the host 200 may perform the operations that have been described with reference to FIGS. 2 through 13.

As described above, according to an exemplary embodiment of the present inventive concept, a file may be encrypted and decrypted using a context ID assigned to each application APP or a file related with the application APP in a memory device, and thus, performance of a system including the memory device and a host may be increased. In addition, since the file is encrypted and decrypted in the memory device (e.g., a mobile storage) instead of the host, security solutions for the host may be simplified.

While the present inventive concept has been particularly shown and described with reference to exemplary embodiments thereof, it will be understood by those of ordinary skill in the art that various changes in forms and details may be made therein without departing from the spirit and scope of the present inventive concept as defined by the following claims.

What is claimed is:

1. A method of operating a system including a memory device and a host, the method comprising:
requesting, by the host, the memory device to transmit a context ID list, wherein the context ID list includes context IDs;
assigning, by the host, a context ID among the context IDs to an application from the context ID list received from the memory device; and
transmitting, by the host, the context ID assigned to the application to the memory device when the host transmits a file corresponding to the application to the memory device, or receives the file from the memory device.

2. The method of claim 1, further comprising:
encrypting, by the memory device, the file using an encryption key corresponding to the application when the memory device receives the file from the host; and
decrypting, by the memory device, the file using the encryption key when the memory device transmits the file to the host.

3. The method of claim 2, further comprising invalidating, by the memory device, the encryption key when an invalidation command and the context ID are received from the host.

4. The method of claim 1, further comprising:
transmitting, by the host, a password to the memory device together with the context ID assigned to the application; and
generating, by the memory device, a first authentication key corresponding to the application using the context ID and the password.

5. The method of claim 4, wherein the password is input by a user.

6. The method of claim 4, wherein the password is input from a server that communicates with the host.

7. The method of claim 4, further comprising:
receiving, by the memory device, a new context ID and a new password from the host after generating the first authentication key;
generating, by the memory device, a second authentication key using the new context ID and the new password; and
comparing, by the memory device, the first authentication key with the second authentication key.

8. The method of claim 7, further comprising: transmitting, by the host, a command and the context ID to the memory device when the first authentication key and the second authentication key are the same as each other;
encrypting, by the memory device, the file using the encryption key when the transmitted command is a write command; and
decrypting, by the memory device, the file using the encryption key when the transmitted command is a read command.

9. A non-transitory computer readable recording medium for recording a computer program for performing the method of claim 1.

10. A method of operating a memory device, the method comprising:
transmitting a context ID list including context IDs to a host in response to a command output from the host;
receiving a context ID among the context IDs and a file from the host, wherein the context ID and the file correspond to an application executed by the host;
encrypting the file using an encryption key corresponding to the context ID; and
storing the encrypted file in the memory device.

11. The method of claim 10, wherein the receiving the context ID and the file comprises:
receiving the context ID and a password corresponding to the context ID from the host;
generating a first authentication key using the context ID and the received password;
receiving a new context ID among the context IDs and a new password from the host;
generating a second authentication key using the new context ID and the new password; and
receiving the context ID and the file when the first authentication key is the same as the second authentication key.

12. The method of claim 11, wherein the first authentication key and the second authentication key are generated using a hash function or an advanced encryption standard (AES).

13. The method of claim 10, wherein the context ID list comprises different encryption keys respectively assigned to the context IDs.

14. The method of claim 10, further comprising:
receiving a read command and the context ID from the host;
decrypting the encrypted file stored in the memory device using the encryption key; and
transmitting the decrypted file to the host.

15. The method of claim 10, further comprising:
receiving an invalidation command and the context ID from the host; and
invalidating the encryption key corresponding to the received context ID in response to the invalidation command.

16. The method of claim 10, wherein the memory device is an embedded multimedia card (eMMC) or a universal flash storage (UFS).

17. A method for operating a system including a memory device and a host, the method comprising:
assigning, by the host, an application and a file generated by the application to a security group having a particular security policy;
assigning, by the host, a context ID to the security group;
transmitting, by the host, the context ID when the application is executed to the memory device;
detecting, by the memory device, a use status of the transmitted context ID;
transmitting, by the memory device, a first response including the detected use status of the context ID to the host;
transmitting, by the host, the file and one of the context ID or an unique ID corresponding to the context ID to the memory device;
encrypting, by the memory device, the file using an encryption key corresponding to the context ID, wherein the encryption key is stored in an internal memory in the memory device; and
storing the encrypted file in the memory device.

18. The method of claim 17, wherein when the use status indicates that the context ID has not been used, the method further comprises the following steps between the transmitting of the first response and the transmitting of the file and one of the context ID or the unique ID;
transmitting, by the host, an authentication request including the context ID to the memory device;
generating, by the memory device, the encryption key corresponding to the context ID;
storing the encryption key in the internal memory; and
transmitting, by the memory device, a second response indicating that the encryption key is generated to the host.

19. The method of claim 17, wherein when the use status indicates that the context ID has not been used, the method further comprises the following steps between the transmitting of the first response and the transmitting of the file and one of the context ID or the unique ID:
transmitting, by the host, an authentication request including the context ID to the memory device;
generating, by the memory device, the encryption key corresponding to the context ID;
generating, by the memory device, the unique ID corresponding to the context ID;
storing, by the memory device, the unique ID in the internal memory; and
transmitting, by the memory device, a second response including the unique ID to the host.

20. The method of claim 19, further comprising comparing, by the memory device, the unique ID transmitted from the host with the unique ID stored in the memory device.
